(19) United States
(12) Patent Application Publication
(10) Pub. No.: US 2011/0157879 A1
(43) Pub. Date: Jun. 30, 2011

(54) LIGHT ASSEMBLY AND METHOD OF MANUFACTURING THE SAME

(75) Inventors: Chan Ching CHANG, Taoyuan County (TW); Szu Han Li, Taoyuan County (TW); Wei Lun Hsiao, Taoyuan County (TW)

(73) Assignee: DU PONT APOLLO LTD., Pak Shek Kok (HK)

(21) Appl. No.: 12/964,439

(22) Filed: Dec. 9, 2010

Related U.S. Application Data
(60) Provisional application No. 61/290,777, filed on Dec. 29, 2009.

(51) Int. Cl. F21L 4/00; B23P 17/04

(52) U.S. Cl. 362/183; 29/428

(57) ABSTRACT

A light assembly is provided, which includes a solar cell, a light guiding plate mounted on one side of the solar cell; a frame releasably holding the solar cell and the light guiding plate; and a LED array releasably mounted within the frame and adjacent to the light guiding plate so that the light generated by the LED array passes through the side surface of the light guiding plate and illuminates the area in front of the light guiding plate or the light guiding plate.

### BACKGROUND OF THE INVENTION

1. Field of the Invention

The present invention relates to a light assembly that uses a light emitting diode (LED) array and a solar cell. More specifically, the present invention relates to a light assembly using a frame so configured that the heat generated from the LED array and/or the solar cell can be dissipated and the method of manufacturing the same.

2. Description of the Related Art

A solar-powered illuminator using a LED as the light-emitting device is widely used for many applications, such as a streetlamp, a warning sign and an indication sign for the road application. Moreover, it is also utilized as an outdoor decoration lamp, a courtyard lamp, a garden lamp or an advertisement lamp. Traditionally, the solar-powered illuminator includes a LED, a solar cell, a rechargeable battery, and a controller. The solar cell receives the sunlight during the daytime and converts the solar energy into the electrical energy to store in the rechargeable battery. During the nighttime, the controller controls the rechargeable battery to discharge the stored electrical energy to drive the LED to emit light. Furthermore, the controller or a sensor is used to detect the intensity of the incident sunlight to provide the information to the controller for deciding when to drive the LED to emit light.

U.S. Published Patent Application No. 2008/0123328 discloses a solar-powered illuminator, wherein the LED and the solar cell are fixed on a frame, and the same region is used for receiving and emitting light. However, since the LED and the solar cell are fixed within the solar-powered illuminator, once the solar cell or the LED is broken, the broken element cannot be replaced without damaging the solar-powered illuminator. Moreover, since the same region is used for receiving and emitting light, the application is limited. For example, it may not be suitable for use as a roof light.

In U.S. Pat. No. 7,226,182, a solar-powered illuminator that has a LED and a solar cell separately mounted within a case is disclosed. With such structure, it is possible to replace the LED and the solar cell without damaging the solar-powered illuminator. Nevertheless, the heat generated by the LED and the solar cell may be accumulated within the case, and affect the stability of the illuminator. Moreover, such solar-powered illuminator uses one surface as both a light receiving area through which a solar cell receives light and a light emitting area through which light is emitted, so there may be partial loss of the sunlight that enters the surface of the light receiving area by as it is scattered and reflected by protrusions and the dichroic mirror coating formed on the light guide plate of the light emitting area. In addition, using one surface for both a light receiving area and a light emitting area may limit the solar-powered illuminator's application, such as for use as a roof light.

Therefore, there is a need to provide a solar-powered illuminator that not only can offer the benefits of solar cell and LED technologies but also is more stable and more economical.

### BRIEF SUMMARY OF THE INVENTION

The present invention provides a more stable and more economical light assembly that uses a solar cell and a light emitting diode (LED) array by dissipating heat efficiently and allowing the solar cell or the LED array be replaced without damaging the light assembly.

The present invention further provides a more stable and more economical light assembly that uses a solar cell and a light emitting diode (LED) array by reducing the incident light loss by not using the same surface as the light receiving surface and the light emitting surface.

Accordingly, one aspect of the present invention is to provide a light assembly, comprising: a solar cell; a light guiding plate mounted on the farthest side of the solar cell from the sunlight; a frame releasably holding the solar cell and the light guiding plate; and a LED array releasably mounted within the frame and adjacent to the light guiding plate so that the light generated by the LED array passes through the side surface of the light guiding plate and illuminates the area in front of the light guiding plate or the light guiding plate.

The light guiding plate can include a light reflection surface on the closest side of the light guiding plate from the solar cell and optionally include a scattering surface on the farthest side of the light guiding plate from the solar cell to improve the uniformity of the light emitted from the light guiding plate.

There is a rechargeable battery in electrical connection with the solar cell and the LED array to store the electricity from the solar cell and energize the LED array. Also, a light sensitive switch circuitry is provided in electrical connection with the rechargeable battery to allow the rechargeable battery depend upon the light of the ambient environment to selectively energize the LED array.

The light assembly can include a reflector mounted within the frame and next to the LED, and so configured that more light generated from the LED can be collected and enter the light guiding plate.

The invention can be widely used for many applications, such as a roof light, or a lighting block on a roof. In addition, it can also be utilized as an outdoor decoration lamp, a courtyard lamp, a garden lamp, an advertisement lamp, a streetlamp, a warning sign, an indication sign for road application, a roof light for a parking lot or bus station, a roof light at a parking lot entrance, or a light on a glass roof (such as a garden or greenhouse roof).

### BRIEF DESCRIPTION OF THE DRAWINGS

FIG. 1 shows a side view of an embodiment configured in accordance with the invention, where a light guiding plate is mounted on the farthest side of the solar cell from the sunlight.

FIG. 2 shows a side view of an embodiment configured in accordance with the invention, where a light guiding plate is mounted on the farthest side of the solar cell from the sunlight and a buffer is provided to help the frame to hold the solar cell and the light guiding plate.

FIG. 3 shows a side view of an embodiment configured in accordance with the invention, which shows a different embodiment of the buffer depicted in FIG. 2.

Like reference numerals refer to corresponding parts throughout the several drawings. Dimensions are not drawn to scale.

### DETAILED DESCRIPTION OF THE INVENTION

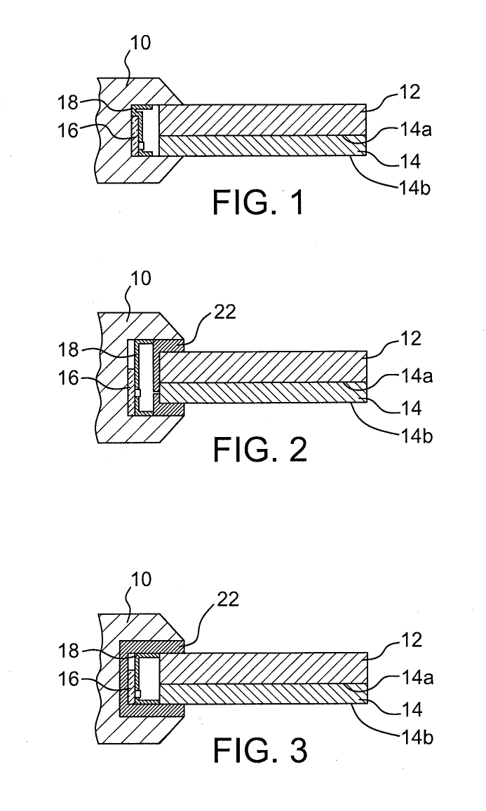

The parts of the solar cell shown in FIGS. 1-3 are examples of the elements recited in the claims. Features from different embodiments described below can be combined together into one embodiment without departing from the scope of the claims.

FIG. 1 shows an embodiment of a light assembly according to the invention, comprising: a solar cell 12, a light guiding plate 14 mounted on the farthest side of the solar cell 12 from the sunlight; a frame 10 releasably holding the solar cell 12 and the light guiding plate 14; and a LED array 16 releasably mounted within the frame 10 and adjacent to the light guiding plate 14 so that the light generated by the LED array 16 passes through the side surface of the light guiding plate 14 and illuminates the area in front of the light guiding plate 14 or the light guiding plate 14.

As the embodiment depicted in FIG. 1, the solar cell 12 and the light guiding plate 14 are releasably held by the frame 10 so that the heat generated from the solar cell 12 can transfer to the frame 10. The solar cell 12 collects the sunlight, generates electricity, and stores the same in a rechargeable battery (not shown) as understood in the art. Presently, solar cells are bulk silicon solar cells, such as single crystal solar cell or poly-crystalline solar cell that uses bulk Si substrates, and thin film solar cell that uses amorphous silicon (a-Si), nanocrystalline silicon (nc-Si), or microcrystalline silicon (mc-Si), where the Si deposits on a substrate such as glass, metal, polymer and/or flexible substrates. In addition, it is also possible to use a dye-sensitized solar cell, an organic/polymer solar cell, or a thin film solar cell that uses Group II-IV compounds in preference to Si or in conjunction with Silicon. Specifically, GaAs, gallium-indium-phosphide (GAInP), copper-indium-gallium-selenide (CIGS), cadmium-telluride/sulphide (CdTe/CdS), or copper-indium-selenide (CuInSe) compounds are deposited on a substrate.

Although only a single solar cell has been discussed and depicted for ease of description, it will be readily recognized that a plurality of solar cells could be utilized in the light assembly to provide increased quantities of electricity.

The light guiding plate 14 is mounted on the farthest side of the solar cell 12 from the sunlight, substantially parallel to the side of the solar cell 12, and comprised of suitable glass or plastic material through which the light may be transmitted, and at least some of the light generated by the LED array 16 passes through the side surface of the light guiding plate 14. At least one surface of the light guiding plate 14 is treated so that it can direct the light generated from the LED array 16 to be in one direction. Specifically, the light guiding plate 14 can include a light reflection surface 14a on the closest side of the light guiding plate 14 from the solar cell 12 and optionally include a scattering surface 14b on the farthest side of the light guiding plate 14 from the solar cell 12 to improve the uniformity of the light emitted from the light guiding plate 14.

A glass or a plastic material such as acrylic resin, poly methyl metacrylate (PMMA) may be used as a transparent material for the light guiding plate 14.

In some embodiments, the closest surface of the light guiding plate 14 from the solar cell should be treated so that it can direct light approximately in one direction as a light reflection surface 14a. Any technology known in the art can be applied for the treatment. For example, protrusions (not shown) may be formed in the light reflection surface 14a, or minor sheet or metal film (not shown) may be coated on the light reflection surface 14a to improve light reflection. To help the light reflection of the light reflection surface 14a, the farthest surface of the light guiding plate 14 from the solar cell may also be treated to be a light scattering surface 14b. Any technology known in the art can be applied for the treatment. For example, a light scattering sheet can be coated on the surface 14b, or minute protrusions and depressions can be formed in the surface 14b by a sandblast process or in a light scattering sheet which is coated on the surface 14b to improve light reflection.

The frame 10 is made of a material that allows heat to dissipate, such as metal material, for example, gold, silver, copper, iron, aluminum, magnesium, titanium or their alloy or metal composite, or plastic material, for example, an engineering plastic, including a carbon composite, a polymer composite, or a ceramic composite that can transfer heat energy efficiently. During the operation, heat energy is transferred from the LED array 16 and/or the solar cell 12 to the frame 10.

The LED array 16 is releasably mounted within or attached to the frame 10. As the embodiment depicted in FIG. 1, the LED array 16 is adjacent to one side of the light guiding plate 14 and suitably arranged such that the heat generated from the LED array 16 will transfer to the frame 10 and at least some of the light generated from the LED array 16 will enter the light guiding plate 14 and illuminate the area in front of the light guiding plate 14 or the light guiding plate 14.

A plurality of LED array may be used depending on the size, the shape or the use of the light assembly. The LED array 16 may emit light having a specific wavelength. That is, there may be a blue, green, or red LED. If it is desired to emit light of such specific wavelengths from the light assembly, a dichroic mirror that selectively reflects light of a specific wavelength may be coated on light refection surface 14a of the light guiding plate 14. The LED array 16 may contain at least one protect circuit, a LED, and a PCB board.

In some embodiments, such as the ones shown in FIG. 1 a reflector 18 can be mounted within the frame 10 and next to the LED, and so configured that more light generated from the LED can enter the light guiding plate 14. The reflector 18 can be mounted on the inner surface of the frame 10 and on the LED array, either partially or entirely. The reflector 18 can be made of material that is understood in the art such as metal such as silver or aluminum, or optical multilayer film. Protrusions (not shown) may be formed in the reflector, or mirror sheet or metal film (not shown) may be coated to improve light reflection.

Further, in some embodiments, there is rechargeable battery (not shown) in electrical connection with the solar cell 12 and the LED array 16 to store the electricity from the solar cell 12 and energize the LED array 16. In some embodiments, a light sensitive switch circuitry (not shown) is provided to allow the rechargeable battery selectively energize the LED array 16 when the ambient light is below a pre-determined level, stop energizing the LED array 16 when the ambient light is above a pre-determined level and enable charging the rechargeable battery by the solar cell 12. The circuitry therefore ensures that, when the ambient environment is dark or the light is below a pre-determined level, the LED array 16 will be turned on, powered by the rechargeable battery, and that when the ambient environment is light or the light is above a pre-determined level, the LED array 16 will be turned off and the rechargeable battery are recharged.

Secondary battery or an electric dual layer capacitor (not shown) may be used for the rechargeable battery. The electric dual layer capacitor is preferred over secondary battery since it has a longer life and is more reliable.

Furthermore, in some embodiments, such as the ones shown in FIGS. 2 and 3, a buffer 22 can be provided between the frame 10 and the solar cell 12 and between the frame 10 and the light guiding plate 14 to help the frame 10 to hold the solar cell 12 and the light guiding plate 14. The buffer 22 can be disposed on the inner surface of the frame 10, either partially or entirely as long as the light emitted from the LED array 16 can enter the light guiding plate 14. For example, as shown in FIG. 2, an opening is provided in the buffer 22 for the corresponding LED array 16. The buffer 22 can be comprised of a material that is understood in the art such as silicone, rubber or plastic such as ethylene-propylene-non-conjugated diene M-class rubber (EPDM). In some buffer embodiments, such as the one shown in FIG. 3, the buffer 22 also can be combined with a reflector 18 or be used as a reflector when coated with a reflection material. If the buffer is coated with a reflection material, the reflector 18 can be eliminated.

One method of manufacturing the light assembly includes: mounting a light guiding plate 14 on the farthest side of a solar cell 12 from the sunlight; releasably mounting a LED array 16 within a frame 10; and using the frame 10 to releasably hold the solar cell 12 and the light guiding plate 14 so that light generated by the LED array 16 passes through the side surface of the light guiding plate 14, wherein the LED array 16 and the solar cell 12 are so configured that the heat generated by the LED array 16 and the solar cell 12 transfers to the frame 10.

In some embodiments, before the solar cell 12 is releasably held by the frame 10, a reflector 18 can be mounted within the frame 10 and next to the LED to help more light generated from the LED to enter the light guiding plate 14.

The manufacture of the light assembly includes means to releasably hold the solar cell 12 and the light guiding plate 14 within the frame 10 and to releasably mount the LED array 16 within the frame 10. In some embodiments, acorn nuts (not shown) are placed in the frame 10 to provide bolt mounting of the solar cell 12 and the light guiding plate 14 to the frame, and/or the bolt mounting of the LED array 16 to the frame 10. In some embodiments, means of mounting can include a bolt or screw placed in the frame 10, an adhesive pad mounted to the frame 10, or a glue on the frame 10.

An operation of the light assembly structured as described above will now be explained.

During daylight hours, the solar cell 12 collects the sunlight, generates electricity, and stores the same in the rechargeable battery (not shown). If the area around the light assembly becomes dark, the light sensitive switch circuitry (not shown) sends an ON signal to the LED array 16. As a result, power stored in the rechargeable battery is transmitted to the LED array 16 and the LED array 16 then operates to emit light. The light emitted from the LED array 16 passes through the side surface of the light guiding plate 14 and lands on light reflection surface 14a thereof. Most of the light is reflected from the light reflection surface 14a, and passes through the light guiding plate 14 and illuminates the area in front of the light guiding plate 14 or the light guiding plate 14. Before the light emits from the light guiding plate 14, the light can be further scattered by the light scattering surface 14b of the light guiding plate 14 to improve the uniformity of the light emitted from the light guiding plate 14.

Since the frame 10 is in contact with both the solar cell 12 and the LED array 16, and the solar cell 12 and the LED array 16 are separate, the heat generated from the solar cell 12 and the LED array 16 during the operation of the light assembly will not accumulate and can dissipate through the frame 10 efficiently.

Since the LED array 16 and the solar cell 12 are separately and releasably attached to the frame 10, the LED array 16 or the solar cell 12 can be replaced without damaging the light assembly. Also, in some embodiments, the light receiving area of the solar cell 12 that collects the sunlight and the light emitting area through which light is emitted through the light guiding plate 14 are not using the same surface. Therefore, there will be no partial loss of the sunlight due to the reflection and/or scattering of the light from the light guiding plate 14.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

We claim:

1. A light assembly comprising:
a solar cell;
a light guiding plate mounted on one side of the solar cell;
a frame releasably holding the solar cell and the light guiding plate; and
a LED array releasably mounted within the frame and adjacent to the light guiding plate so that the light generated by the LED array passes through the side surface of the light guiding plate and illuminates the area in front of the light guiding plate or the light guiding plate.

2. The light assembly of claim 1, wherein the solar cell is a single crystal solar cell, poly-crystalline solar cell, thin film solar cell or plastic solar cell.

3. The light assembly of claim 1, wherein the light guiding plate includes a light reflection surface on the closest side of the light guiding plate from the solar cell.

4. The light assembly of claim 3, wherein the light guiding plate includes a scattering surface on the farthest side of the light guiding plate from the solar cell.

5. The light assembly of claim 1, wherein the light guiding plate comprises glass or plastic material.

6. The light assembly of claim 5, wherein the plastic material is poly methyl metacrylate (PMMA).

7. The light assembly of claim 1, wherein the frame is made of a metal or plastic material.

8. The light assembly of claim 7, wherein the metal material is selected from the group consisting of gold, silver, copper, iron, aluminum, magnesium, titanium, an alloy thereof and a metal composite.

9. The light assembly of claim 7, wherein the plastic material is an engineering plastic selected from the group consisting of carbon composite, polymer composite, and ceramic composite.

10. The light assembly of claim 1, further comprising a rechargeable battery in electrical connection with the solar cell and the LED array.

11. The light assembly of claim 10, further comprising a light sensitive switch circuitry in electrical connection with the rechargeable battery to allow the rechargeable battery selectively energize the LED array depending upon the light of the ambient environment.

12. The light assembly of claim 1, further comprising a reflector mounted next to the LED, and so configured that more light generated from the LED can enter the light guiding plate.

13. The light assembly of claim 1, further comprising a plate opposing to the light guiding plate mounted on the other side of the solar cell.

14. The light assembly of claim 1, further comprising a buffer disposed between the frame and the solar cell, and between the frame and the light guiding plate.

15. The light assembly of claim 14, wherein the buffer is coated with a reflection material.

16. A method of manufacturing a light assembly according to claim 1, comprising:
mounting a light guiding plate on one side of a solar cell from the sunlight;
releasably mounting a LED array within a frame; and
using the frame to releasably hold the solar cell and the light guiding plate so that light generated by the LED array passes through the side surface of the light guiding plate, wherein the LED array and the solar cell are so configured that the heat generated by the LED array and the solar cell transfers to the frame.

17. The method of claim 16, wherein the frame is made of a metal or plastic material.

18. The method of claim 17, wherein the metal material is selected from the group consisting of gold, silver, copper, iron, aluminum, magnesium, titanium, an alloy thereof and a metal composite.

19. The method of claim 17, wherein the plastic material is an engineering plastic selected from the group consisting of carbon composite, polymer composite, and ceramic composite.
